(19) United States
(12) Patent Application Publication
(10) Pub. No.: US 2025/0330668 A1
(43) Pub. Date: Oct. 23, 2025

(54) METHOD AND APPARATUS FOR DISPLAYING INFORMATION, ELECTRONIC DEVICE, AND PRODUCT

(71) Applicant: Beijing Youzhuju Network Technology Co., Ltd., Beijing (CN)

(72) Inventors: Wei LUO, Beijing (CN); Lin ZHU, Beijing (CN); Xiaojiao ZHONG, Beijing (CN)

(21) Appl. No.: 19/171,678

(22) Filed: Apr. 7, 2025

(30) Foreign Application Priority Data
Apr. 19, 2024 (CN) 202410480273.4

(51) Int. Cl. H04N 21/431; H04N 21/4722

(52) U.S. Cl. CPC H04N 21/4316; H04N 21/4722

(57) ABSTRACT

Embodiments of the present disclosure relate to a method and apparatus for displaying information, an electronic device, and a product. The method includes displaying, in response to an interaction behavior meeting a trigger condition, a target control on a media playback page, where the target control at least displays object attribute information of a target object, and the target control is used to prompt a user to trigger a preset interaction operation; and the target object is determined according to object attribute information and/or business attribute information of each object in an object collection corresponding to the media playback page. In addition, the method further includes adjusting content displayed in the target control to prompt information associated with the target object in response to interaction information of the object attribute information of the target object meeting a preset condition, to prompt the user to trigger the preset interaction operation.

### CROSS-REFERENCE TO RELATED APPLICATION(S)

This application claims priority to Chinese Application No. 202410480273.4 filed on Apr. 19, 2024, the disclosure of which is incorporated herein by reference in its entirety.

### FIELD

The present disclosure generally relates to the field of computer software, and more specifically, to a method and apparatus for displaying information, an electronic device, and a product.

### BACKGROUND

In various applications, especially on media playback pages such as a picture playback page and a video playback page, controls that can present an object collection after being triggered are often provided, and these controls are known as object list trigger controls. The object list trigger control may include, for example, a share button. After a user taps the share button, several share objects can be presented on the media playback page. For example, the share objects may be friends within the applications or other applications such as social media applications and instant messaging applications.

A plurality of objects are organized using the object list trigger control, so as to avoid excessive or overly crowded visual elements on the media playback page, thereby maintaining the simplicity of the page design. Especially on a mobile device with limited screen space, the object list trigger control needs to be frequently used to save visual controls on the media playback page.

### SUMMARY

In a first aspect of embodiments of the present disclosure, a method for displaying information is provided. The method includes displaying, in response to an interaction behavior meeting a trigger condition, a target control on a media playback page, where the target control at least displays object attribute information of a target object, and the target control is used to prompt a user to trigger a preset interaction operation, and the target object is determined according to object attribute information and/or business attribute information of each object in an object collection corresponding to the media playback page. In addition, the method further includes adjusting content displayed in the target control to prompt information associated with the target object in response to interaction information of the object attribute information of the target object meeting a preset condition, to prompt the user to trigger the preset interaction operation.

In a second aspect of the embodiments of the present disclosure, an apparatus for displaying information is provided. The apparatus includes a target control display module, configured to display a target control on a media playback page in response to an interaction behavior meeting a trigger condition, where the target control at least displays object attribute information of a target object, and the target control is used to prompt a user to trigger a preset interaction operation; and the target object is determined according to object attribute information and/or business attribute information of each object in an object collection corresponding to the media playback page. The apparatus further includes a display content adjustment module, configured to adjust content displayed in the target control to prompt information associated with the target object in response to interaction information of the object attribute information of the target object meeting a preset condition, to prompt the user to trigger the preset interaction operation.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for displaying information. The method includes displaying, in response to an interaction behavior meeting a trigger condition, a target control on a media playback page, where the target control at least displays object attribute information of a target object, and the target control is used to prompt a user to trigger a preset interaction operation; and the target object is determined according to object attribute information and/or business attribute information of each object in an object collection corresponding to the media playback page. In addition, the method further includes adjusting content displayed in the target control to prompt information associated with the target object in response to interaction information of the object attribute information of the target object meeting a preset condition, to prompt the user to trigger the preset interaction operation.

In a fourth aspect of the embodiments of the present disclosure, a computer program product is provided. The computer program product is tangibly stored on a non-transitory computer-readable medium and includes machine-executable instructions, and the machine-executable instructions, when executed, cause a machine to implement a method for displaying information. The method includes displaying, in response to an interaction behavior meeting a trigger condition, a target control on a media playback page, where the target control at least displays object attribute information of a target object, and the target control is used to prompt a user to trigger a preset interaction operation; and the target object is determined according to object attribute information and/or business attribute information of each object in an object collection corresponding to the media playback page. In addition, the method further includes adjusting content displayed in the target control to prompt information associated with the target object in response to interaction information of the object attribute information of the target object meeting a preset condition, to prompt the user to trigger the preset interaction operation.

In a fifth aspect of the embodiments of the present disclosure, a non-transitory computer-readable medium is provided. The computer-readable medium has machine-executable instructions stored therein. The machine-executable instructions, when executed, cause a machine to implement a method for displaying information. The method includes displaying, in response to an interaction behavior meeting a trigger condition, a target control on a media playback page, where the target control at least displays object attribute information of a target object, and the target control is used to prompt a user to trigger a preset interaction operation; and the target object is determined according to object attribute information and/or business attribute information of each object in an object collection corresponding to the media playback page. In addition, the method further includes adjusting content displayed in the target control to prompt information associated with the target object in response to interaction information of the object attribute information of the target object meeting a preset condition, to prompt the user to trigger the preset interaction operation.

The section Summary is provided to introduce concept selection in a simplified form, which will be further described in the following specific implementations. The section Summary is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in conjunction with the accompanying drawings and with reference to following detailed descriptions. In the accompanying drawings, the same or similar reference numerals denote the same or similar elements.

FIG. 1A to FIG. 1B illustrate schematic diagrams of an example environment where a plurality of embodiments of the present disclosure may be implemented;

FIG. 2 illustrates a flowchart of a method for displaying information according to some embodiments of the present disclosure;

FIG. 3A to FIG. 3B illustrate schematic diagrams of an example of displaying an image of a target object in a target control and automatically adjusting for displaying a prompt text according to some embodiments of the present disclosure;

FIG. 4A to FIG. 4B illustrate schematic diagrams of an example of displaying images of a group of target objects in a target control and automatically adjusting for displaying a prompt text for the group of target objects according to some embodiments of the present disclosure;

FIG. 5A to FIG. 5B illustrate schematic diagrams of an example of an animation effect of an object list trigger control, a target control, and a comment list control according to some embodiments of the present disclosure;

FIG. 6A to FIG. 6B illustrate schematic diagrams of an example of displaying an object list by triggering a target control according to some embodiments of the present disclosure;

FIG. 7A to FIG. 7B illustrate schematic diagrams of an example of displaying detailed information of a target object by triggering the target object in a target control according to some embodiments of the present disclosure;

FIG. 8 illustrates a block diagram of an apparatus for displaying information according to some embodiments of the present disclosure; and

FIG. 9 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, that is, “including but not limited to”. The term “based on” should be understood as “at least partially based on”. The term “an embodiment” or “this embodiment” should be understood as “at least one embodiment”. The terms “first”, “second”, etc. may refer to different or identical objects, unless otherwise explicitly specified. Other explicit and implicit definitions may also be included below.

In the description of the embodiments of the present disclosure, a “media playback page” refers to a page used to display text content, image content, video content, or any combination thereof. The image content includes, but is not limited to, static image content, dynamic image content, image content with sound, image content without sound, etc. The video content includes, but is not limited to, a short video, a long video, a recorded video, a live video, etc. The “object” refers to any item that can be organized in a list form, including but not limited to, a user account (e.g., a user account to which media content is shared), an in-app function (e.g., video quality selection and playback speed adjustment), a frequently asked question, an item or information associated with the media content, a resource that the user can send to a media content provider, etc. In addition, the “object collection” refers to a presentation form of organizing the objects in the list form, where the plurality of objects in the object collection may be objects with the same attributes (e.g., all objects associated with the media content), or may also be objects with different attributes (e.g., a part of objects in a share list may be user accounts, and the other part of objects may be third-party applications such as social media applications and instant messaging applications). A “control” refers to a visual element on a user interface.

As described above, object list trigger controls are often provided on the media playback page, such as a share button, a frequently asked question button, a related content recommendation button, and a comment button. After these object list trigger controls are triggered, the object collection including the plurality of objects may be displayed on the media playback page. The user may check the object collection by, for example, swiping up and down on a screen. In some implementations, if the user is interested in a certain object, the object may be tapped to check detailed information related to the object. In this way, visual elements on the media playback page can be prevented from being overcrowded, thereby maintaining the simplicity of page design.

However, while pursuing the simple design, it may result in some important functions and information becoming inconspicuous or unintuitive, hindering the user from discovering and using these functions and information. When these functions and information are hidden behind the object list trigger controls, the user may be completely unaware of the existence of these functions. Unless users actively explore the functions of these controls, they may not discover or use these functions for a long time. For new users or users who do not frequently use the application, the design may cause them to miss useful functions and information, or may confuse the users who cannot find the desired functions.

In some related technologies, designers typically use icons to represent the object list trigger controls. To prompt the user to tap the icon, besides designing the icon with a pattern that represents a corresponding function, attention of the user may also be drawn by adding an animation (e.g., stars or ribbons appearing around the icon) to the icon. However, although the solution successfully attracts the attention of the user, it still fails to effectively inform the user of the functions and information hidden behind the icon, causing that the user lacks the motivation to tap the icon.

In view of this, embodiments of the present disclosure provide a solution for displaying information. In the solution, if an interaction behavior meets a trigger condition, a target control may be displayed on the media playback page. The target control at least displays object attribute information of a target object and may be used to prompt the user to trigger a preset interaction operation. In addition, the target object may be determined according to object attribute information and/or business attribute information of each object in an object collection corresponding to the media playback page. In addition, if interaction information of the object attribute information of the target object meets a preset condition, content displayed in the target control may be adjusted to prompt information associated with the target object, thereby prompting the user to trigger the preset interaction operation.

In this way, when the user views the object attribute information in the target control, the user may intuitively learn what information or functions are hidden behind the icons of the object list trigger controls, thereby increasing a click-through rate of the object list trigger controls. Moreover, after viewing the object attribute information in the target control, the user may also view the prompt information associated with the target object, thereby allowing the user to further understand that the target object in the target control may be found by tapping the object list trigger controls, or further improving the interest of the user in tapping the object list trigger controls, so as to further increase the click-through rate of the object list trigger controls. In addition, by sequentially displaying the object attribute information and the prompt information, the number of the controls and the size of areas of the controls on the page can be reduced, the simplicity of the media playback page is improved, and the display efficiency of the media content is improved.

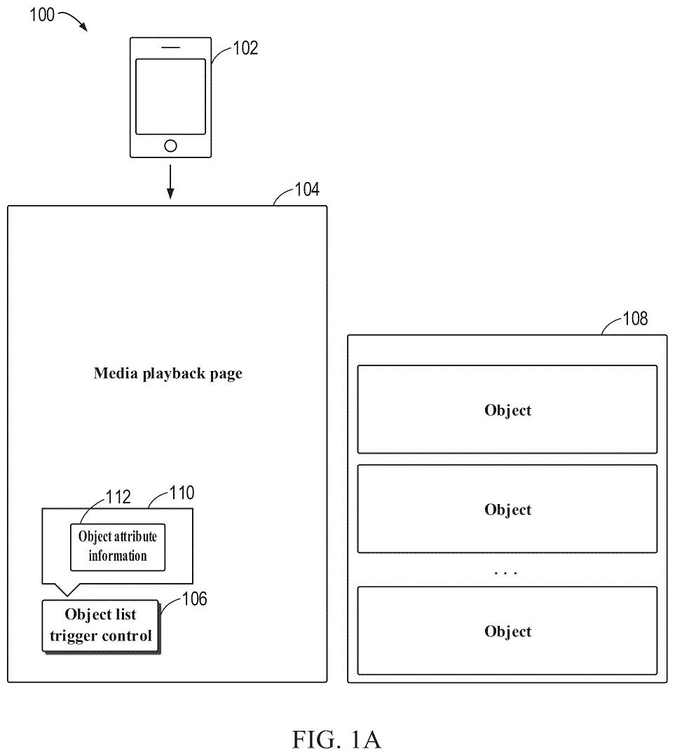

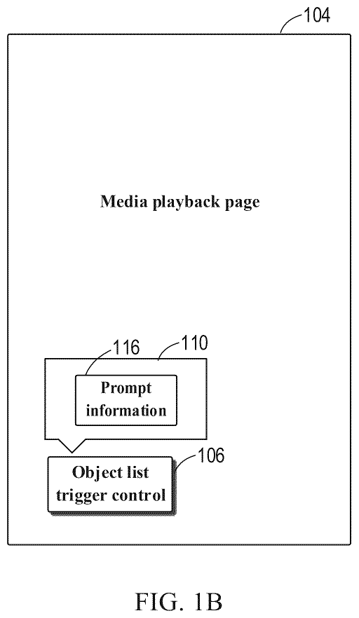

FIG. 1A to FIG. 1B illustrate schematic diagrams of an example environment 100 where a plurality of embodiments of the present disclosure may be implemented. As shown in FIG. 1A, the environment 100 includes a user device 102, and the user device 102 may be any device that can run an application including a media playback page 104. For example, the user device 102 may be a mobile phone, a tablet computer, a smart wearable device, a laptop computer, a desktop computer, etc. The media playback page 104 is used to display media content, and the media content includes text content, image content, video content, or any combination thereof. For example, the media playback page 104 may be a video live streaming page, a page for playing a pre-recorded video, or a slideshow playback page.

The media playback page 104 includes an object list trigger control 106, and the object list trigger control 106 may be presented in the form of an icon. When the user triggers (e.g., tap or touch) the object list trigger control 106, an object list 108 may be displayed on the media playback page 104, and the object list 108 includes at least one object. For example, when the object list trigger control 106 corresponds to a share function, the object may be a user account to which the media content is shared. When the object list trigger control 106 corresponds to a related content recommendation function, the object may be an item or information associated with media content that is currently played. For example, when the media content that is currently played is a dressing guide, the objects in the object list 108 may include clothes from the media content and other related clothes.

In the environment 100, when the user is watching the media content on the media playback page 104, if an interaction behavior of the user with the media playback page 104 meets a trigger condition, a target control 110 may be automatically displayed, and object attribute information 112 associated with the target object may be displayed in the target control 110. The target control 110 may be, for example, a control such as a tooltip bubble, and the object attribute information 112 may be, for example, an image or text description of the target object. For example, in the example of the media content being the dressing guide, the target object may be clothes being commented on, and the object attribute information 112 may be a picture of the clothes. When interaction information of the object attribute information 112 of the target object meets a preset condition (e.g., after a period of time, such as 3 seconds, 5 seconds, or longer), the content displayed in the target control 110 may be automatically adjusted to prompt information associated with the target object.

As shown in FIG. 1B, the display content of the target control 110 is adjusted to prompt information 116 from the object attribute information 112. In some examples, the prompt information 116 may be information that prompts the user to find the target object corresponding to the displayed object attribute information 112 by tapping the object list trigger control 106 (e.g., “Here”). In some examples, the prompt information 116 may be other information (e.g., “Popular outfit combinations”) that is associated with the target object, beyond the object attribute information 112. Therefore, the correlation between the object attribute information 112 and the prompt information 116 can be visually improved, thereby guiding the user to find the target object by tapping the object list trigger control 106 or the target control 110.

In this way, the user may view the target object hidden behind the object list trigger control 106 through the object attribute information 112, thereby increasing the click-through rate of the object list trigger control 106. In addition, the prompt information 116 can further guide the user to tap the object list trigger control 106, thereby further increasing the click-through rate of the object list trigger control 106. In addition, by sequentially displaying the object attribute information 112 and the prompt information 116, the number of controls and the size of the controls on a screen can be reduced, the simplicity of the media playback page is improved, and the display efficiency of the media content is improved.

FIG. 2 illustrates a flowchart of a method 200 for displaying information according to some embodiments of the present disclosure. The method 200 may be, for example, implemented by the user device 102 shown in FIG. 1A. As shown in FIG. 2, at a block 202, in response to an interaction behavior meeting a trigger condition, through the method 200, a target control may be displayed on a media playback page, where the target control at least displays object attribute information of a target object, the target control is used to prompt the user to trigger a preset interaction operation, and the target object is determined according to object attribute information and/or business attribute information of each object in an object collection corresponding to the media playback page. For example, in the environment 100 shown in FIG. 1A, the user device 102 may display the object list trigger control 106 on the media playback page 104, and after the user taps the object list trigger control 106, the object list 108 may be displayed on the media playback page 104. If the interaction behavior of the user meets the trigger condition, the target control 110 may be displayed on the media playback page 104. The target control 110 may display the object attribute information 112, and is used to prompt the user to trigger the preset interaction operation, such as tapping the object list trigger control 106 or the target control 110. The target object is determined according to the object attribute information (e.g., an object category and an object name) and/or the business attribute information (e.g., ranking in the list, and an association relationship between the objects) of each object in the object list 108 corresponding to the media playback page 104.

In some examples, the media content displayed on the media playback page 104 may be a video of a dressing guide, the object list trigger control 106 may be a button that provides a function of viewing related content, the object list 108 may be a clothes list, and the object list 108 may also include clothes in the video. The target object may be clothes in the video, clothes with similar characteristics to the clothes in the video, or any other clothes. In these examples, the object attribute information 112 may be a picture, a name, etc. of the clothes.

At a block 204, in response to interaction information of the object attribute information of the target object meeting a preset condition (also known as a first preset condition herein), through the method 200, content displayed in the target control may be adjusted to prompt information associated with the target object, thereby prompting the user to trigger the preset interaction operation. For example, in the environment 100 shown in FIG. 1A to FIG. 1B, when the interaction information of the object attribute information 112 meets the preset condition, the user device 102 may adjust the content in the target control 110 to the prompt information 116 from the object attribute information 112, thereby prompting the user to trigger the preset interaction operation. In an example of the dressing guide, the prompt information 116 may prompt the user to tap the object list trigger control 106 to find clothes corresponding to the object attribute information 112 (e.g., “Here”). In addition, the prompt information 116 may also be a supplementary description about the clothes corresponding to the object attribute information 112 (e.g., “Trending this summer”).

In this way, when the user views the object attribute information in the target control, the user can intuitively learn what information or functions are hidden behind the icon of the object list trigger control, thereby increasing the click-through rate of the object list trigger control. Moreover, after viewing the object attribute information in the target control, the user may also view the prompt information associated with the target object, thereby allowing the user to further understand that the target object in the target control may be found by tapping the object list trigger control, or further improving the interest of the user in tapping the object list trigger control, so as to further increase the click-through rate of the object list trigger control. In addition, by sequentially displaying the object attribute information and the prompt information at different controls, the number of the controls on the page can be reduced, the simplicity of the media playback page is improved, and the display efficiency of the media content is improved.

In some embodiments, the object attribute information of the target object may be an image or text information describing attributes of the target object, and the object attribute information of the target object may include at least one of the following: a name, a category, a text description, and an image. In some embodiments, to increase the user interest in the target object, the object attribute information associated with the object collection may include an image of the target object, and the prompt information may include text information indicating how to view the object collection or text information for a supplementary description of the object attribute information of the target object.

In some embodiments, the interaction information of the object attribute information of the target object is information updated when interaction with the object attribute information of the target object is detected, or statistical information associated with the object attribute information of the target object. In some embodiments, if the interaction information of the prompt information meets another preset condition (also known as a second preset condition herein), the target control may be hidden. Then, information indicating the number of objects in the object collection may be displayed above the object list trigger control or within a preset range of the object list trigger control. For example, the number of the objects in the object collection may be displayed at a top right corner of the object list trigger control. Therefore, the object list trigger control is more prominent, and a number at the top right corner may encourage the user to tap the object list trigger control, thereby increasing the click-through rate of the object list trigger control.

In some embodiments, if the display time of the object attribute information of the target object exceeds a certain time threshold (also known as a first time threshold herein), the content displayed in the target control may be adjusted to prompt information associated with the target object. If the display time of the prompt information exceeds another time threshold (also known as a second time threshold herein), the target control may be hidden.

In some embodiments, if interaction with the object attribute information of the target object is detected, the content displayed in the target control may be adjusted to the prompt information. For example, if the user taps the object attribute information of the target object, the content displayed in the target control may be adjusted to the prompt information. In some embodiments, if it is detected that the interaction with the object attribute information of the target object has ended, the content displayed in the target control may be adjusted to the prompt information. For example, if the user holds down the object attribute information of the target object to view the information and then releases, the content displayed in the target control may be adjusted to the prompt information.

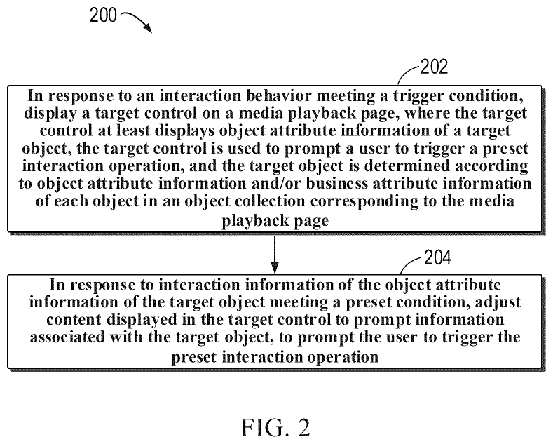

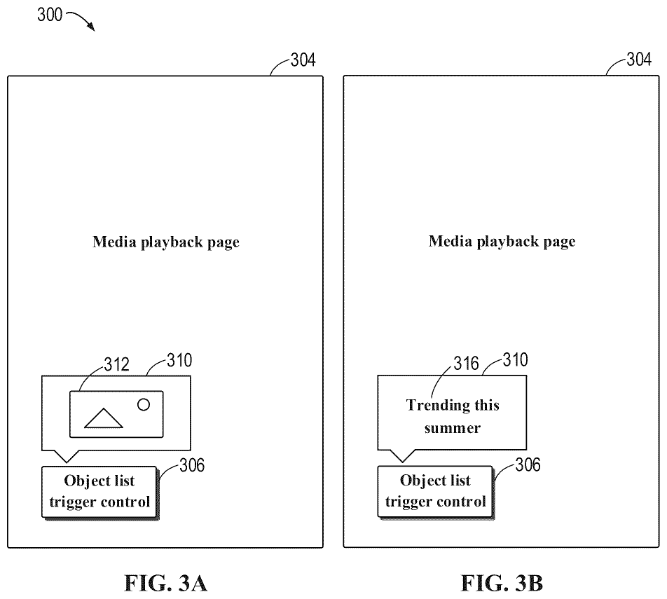

FIG. 3A to FIG. 3B illustrate schematic diagrams of an example 300 of displaying an image of a target object in a target control and automatically adjusting for displaying a prompt text according to some embodiments of the present disclosure. As shown in FIG. 3A, in the example 300, a media playback page 304 includes an object list trigger control 306, and if the user triggers the object list trigger control 306, an object collection may be displayed on the media playback page 304. In the example 300, if an interaction behavior of the user on the media playback page 304 meets a trigger condition, a target control 310 may be displayed on the media playback page 304, and the target control 310 may display an image 312 of a target object in the object collection. For example, in the above example of the dressing guide, the image 312 may be a picture of clothes.

The image 312 may be displayed continuously for a period of time, and when the display time exceeds a certain time threshold (e.g., 3 seconds, 5 seconds, or longer), the content displayed in the target control 310 may be automatically adjusted from the image 312 to a prompt text 316 shown in FIG. 3B. The prompt text 316 is used to allow the user to be interested in the target object, which may be text information related to how to view the object collection (e.g., “Here” or “Tap here”). The prompt text 316 may also be text information for a supplementary description of the image 312 of the target object. For example, the prompt text 316 may be a description of characteristics of the target object, the number of users who like or favorite the target object, a discount on the target object, etc. For example, in the example 300, the prompt text 316 may be “Trending this summer”.

The prompt text 316 may also be displayed continuously for a period of time, and when the display time exceeds another time threshold (e.g., 3 seconds, 5 seconds, or longer), the target control 310 may be automatically hidden. Therefore, an animation effect may be achieved, and includes displaying the target control, displaying the image in the target control, adjusting the content in the target control from the image to the prompt text, and hiding the target control. The user can be prompted appropriately about information hidden within the object list trigger control 306, and meanwhile disturbance to the user from the prompt can be reduced.

It should be noted that a display duration of the image 312 and a display duration of the prompt text 316 may be the same or different. In addition, a style and a size of the target control 310 when displaying the image 312 may be the same as or different from those when displaying the prompt text 316. For example, in some implementations, since a length of the prompt text 316 may be greater than a width of the image 312, a width of the target control 310 may be adjusted to a larger width when the content is adjusted to the prompt text 316. In some other implementations, the target control 310 may include a plurality of images, and therefore as the content is adjusted to the prompt text 316, the width of the target control 310 may be adjusted to a smaller width.

In this way, when the user watches a video of the dressing guide on the media playback page 304, the image 312 (e.g., a picture of clothes) may be automatically displayed near the object list trigger control 306. When the attention of the user is drawn to the image 312, the prompt text 316 (e.g., “Trending this summer”) may subsequently appear in the position of the image 312. Accordingly, the interest of the user in the clothes in the image 312 can be increased, and then the user may tap the object list trigger control 306 to view the clothes in the image 312. Therefore, the method may use rich content forms to attract the user to tap the object list trigger control 306, thereby increasing the click-through rate of the object list trigger control 306.

In some embodiments, the target control 310 may be displayed within a preset distance from the object list trigger control 306. Accordingly, since the target control 310 is close to the object list trigger control 306, a relation between the target control 310 and the object list trigger control 306 may be strengthened, thereby increasing the probability that the user taps the object list trigger control 306 after viewing the target control 310.

In some embodiments, to further guide the user to tap the object list trigger control, there may be a plurality of target objects displayed in the target control, and the plurality of target objects meet at least one of the following conditions: a value of a preset attribute of a target object among the plurality of target objects meeting a preset attribute threshold, where the preset attribute threshold is determined according to values of preset attributes of objects other than the plurality of target objects, or the plurality of target objects are a group of objects with an association relationship. In some embodiments, when the plurality of target objects are a group of objects with the association relationship in the object list, to inform the user of the reason for displaying these objects together, the prompt information displayed by the target control may be information describing the association relationship between the plurality of target objects, or business information indicating a combination of the plurality of target objects. The business information may be, for example, activity information or promotional information for the object combination.

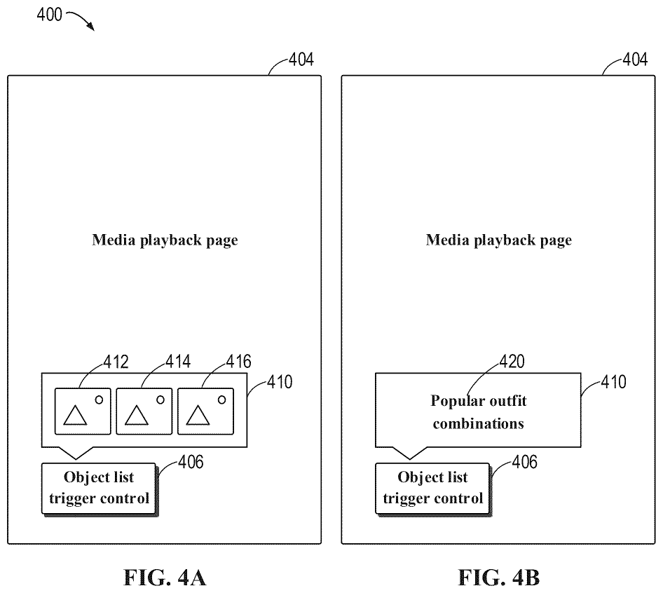

FIG. 4A to FIG. 4B illustrate schematic diagrams of an example 400 of displaying images of a group of target objects in a target control and automatically adjusting for displaying a prompt text for the group of target objects according to some embodiments of the present disclosure. As shown in FIG. 4A, in the example 400, a media playback page 404 includes an object list trigger control 406, and if the user triggers the object list trigger control 406, an object list may be displayed on the media playback page 404. If an interaction behavior of the user on the media playback page 404 meets a trigger condition, a target control 410 may be displayed on the media playback page 404. In the example 400, the target control 410 may include a plurality of pieces of object attribute information, namely, images 412, 414, and 416, and each piece of the object attribute information may correspond to a different target object.

A plurality of target objects corresponding to the images 412, 414, and 416 may be determined because values of preset attributes of the plurality of target objects meet a preset attribute threshold, and the preset attribute threshold is determined according to values of preset attributes of other objects in addition to the plurality of target objects. For example, the preset attribute may be the number of likes, favorites, or purchases of the object, and the preset attribute threshold may be, for example, a value greater than the number of likes, favorites, or purchases of other objects. In other words, the plurality of target objects corresponding to the images 412, 414, and 416 may be objects in the object collection that have the highest number of likes, favorites, or purchases. In some embodiments, the images 412, 414, and 416 may be three objects on a top or close to the top of the object list displayed after the object list trigger control 406 is tapped. In this way, the objects that the user is most interested in may be determined from the object collection, and these objects are exposed outside the object list trigger control 406 (i.e., exposed into the target control 410), thereby improving the interest of the user in the objects hidden behind the object list trigger control 406, and increasing the click-through rate of the object list trigger control 406.

In some embodiments, the images 412, 414, and 416 may be a group of objects with an association relationship in the object collection. For example, the image 412 may be an image of clothes, the image 414 may be an image of pants, and the image 416 may be an image of a pair of shoes, which may collectively form a popular outfit combination. In some embodiments, one of the images 412, 414, and 416 may correspond to an object within the media content currently played on the media playback page 404. In this way, a group of objects with the association relationship may be used to encourage the user to view more information related to the group of objects, thereby increasing the click-through rate of the object list trigger control 406.

In the example 400, after the images 412, 414, and 416 are displayed continuously for a period of time, the content displayed in the target control 410 may be automatically adjusted to a prompt text 420 shown in FIG. 4B. In FIG. 4B, the prompt text 420 may be a text describing the association relationship of the images 412, 414, and 416. Accordingly, the prompt text 420 may provide a further description of the plurality of pieces of object attribute information displayed in the target control 410. For example, in the example 400, the prompt text 420 may be “Popular outfit combinations”, which may prompt the user that the previously displayed clothes, pants, and shoes are a great match together. The prompt text 420 may also be business information indicating a combination of the objects in the images 412, 414, and 416, such as promotional information for the object combination in the images 412, 414, and 416. In this way, the prompt text 420 may further improve the interest of the user in the objects in the images 412, 414, and 416, thereby increasing the click-through rate of the object list trigger control 406.

In some embodiments, the media playback page may display a comment list control (also known as a comment list control herein) for displaying a comment list, and the comment list control is located above the object list trigger control. To reduce the obstruction of the content on the media playback page by the target control, the target control may be displayed above the object list trigger control and below the comment list control, while a height of the comment list control is kept unchanged. In some embodiments, to enhance a display effect of the target control, when the target control is displayed, the comment list control may be moved upwards, and meanwhile the target control is displayed above the object list trigger control and below the comment list control.

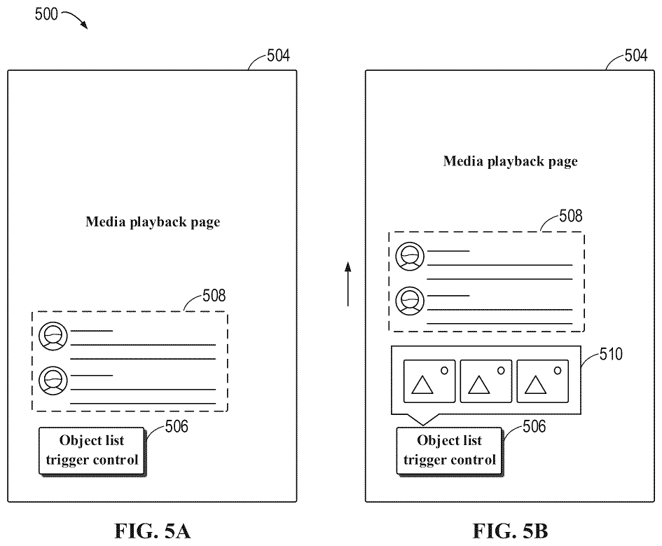

FIG. 5A to FIG. 5B illustrate schematic diagrams of an example 500 of an animation effect of an object list trigger control, a target control, and a comment list control according to some embodiments of the present disclosure. As shown in FIG. 5A, in the example 500, a media playback page 504 includes an object list trigger control 506 and a comment list control 508. The comment list control 508 may display user comments on media content (e.g., a video) on the media playback page 504. In some implementations, the comments in the comment list control 508 may be arranged according to comment creation time, with the most recently created comment displayed at a bottom of the comment list control 508, and previous comments scrolling upwards. To prevent the target control from obstructing the content of the comment list control 508, particularly the latest comment at the bottom of the comment list control 508, when the target control is displayed, a display position of the comment list control 508 may be changed with the height unchanged, and a new display position may be located above the original display position. Then, the target control may be displayed above the object list trigger control 506 and the comment list control 508.

As shown in FIG. 5B, when the target control 510 is displayed, the display position of the comment list control 508 is changed to be above the original display position, and then the target control 510 may be displayed between the object list trigger control 506 and the comment list control 508. Compared with displaying the target control 510 on an upper layer of the comment list control 508 without changing the position of the comment list control 508, the method can reduce the obstruction of the comment list control 508, especially the obstruction of the latest comment at the bottom of the comment list control 508.

In some embodiments, since the comments in the comment list control 508 are updated by scrolling upwards, the position may be changed by using an upward moving animation effect when the position of the comment list control 508 is changed, and the target control 510 may be displayed while the comment list control 508 moves upwards. After the display of the object attribute information and the prompt information in the target control 510 is completed, the target control 510 may be hidden, and the comment list control 508 may move downwards to return to the original position.

In this way, visually, the target control 510 appears like a new comment in the position where a new comment should originally appear, and other comments may scroll upwards accordingly. Therefore, the display effect of the media playback page 504 can be improved, and unity and simplicity of visual design are enhanced.

In some embodiments, the target control may be displayed based on some preset conditions being met. In some embodiments, when triggering of the display of the media playback page is detected, the target control may be displayed. After the object attribute information and the prompt information are sequentially displayed in the target control, the target control may be hidden. In this way, the user may be prompted about the content within the object list trigger control before immersing in the media content, thereby minimizing disturbance to the user.

In some embodiments, if it is detected that the number of triggers for displaying the object collection (e.g., the number of taps on the object list trigger control) is less than a preset threshold, the target control may be displayed. The preset threshold may be, for example, 1, 3, 5, or other values. If the number of taps on the object list trigger control by the user is low, it indicates that the user may be a new user, or a user who is unfamiliar with functions of the object list trigger control. Therefore, the method may prompt the new user and the user unfamiliar with the object list trigger control about the content hidden behind the object list trigger control, thereby reducing disturbance to the user familiar with the application.

In some embodiments, if it is detected that the number of triggers for displaying the object list trigger control (e.g., the number of taps on the object list trigger control) within preset time is less than a preset threshold, the target control may be displayed. The preset time may be, for example, one week, one month, or other time, and the preset threshold may be, for example, 1, 3, 5, or other values. For example, if the number of taps on the object list trigger control by the user within one month is less than one, it indicates that the user may not frequently use the function (or even the application), and therefore the user may have forgotten about the functions of the object list trigger control. Therefore, the method may prompt these users about the functions of the object list trigger control, thereby reducing disturbance to the user familiar with the application.

In some embodiments, if it is detected that dwell time on the media playback page exceeds a preset threshold, the target control may be displayed. The preset threshold may be, for example, 30 seconds, 1 minute, or other values. For example, if the user enters the current media playback page and continuously watches the media content on the current page for 1 minute, it indicates that the user is interested in the media content and may also be interested in the content hidden within the object list trigger control. Therefore, the method may prompt these users to tap the object list trigger control to find information they are interested in, thereby increasing the click-through rate of the object list trigger control.

In some embodiments, if it is detected that the media content on the media playback page is switched to content associated with the target object, the target control may be displayed. For example, in some applications, the user is allowed to switch the media content on the media playback page, or the media content is a live video where a streamer is allowed to switch the media content (e.g., the streamer finishes introducing current clothes and starts introducing another clothes). In this case, as the media content switches, the object in the media content is correspondingly switched to the target object, and the object attribute information in the target control may also be correspondingly switched to information associated with the target object. Therefore, when the media content is switched to the content associated with the target object, the target control is displayed to allow the user to promptly learn about the information that is hidden within the object list trigger control and associated with the target object, thereby increasing the click-through rate of the object list trigger control.

In some embodiments, if it is detected that the time of playing the media content associated with the target object on the media playback page exceeds a preset threshold, the target control may be displayed. The preset threshold may be, for example, 30 seconds, 1 minute, or other values. For example, in the above scenario where media content switching is allowed, if the user watches the media content associated with the target object for more than one minute, it indicates that the user is interested in the target object, and therefore the user may also be interested in the content hidden within the object list trigger control. Therefore, the method may prompt these users to tap the object list trigger control to find information they are interested in, thereby increasing the click-through rate of the object list trigger control.

In some embodiments, an administrator of the media playback page may perform a trigger operation for displaying the target control. For example, in the scenario of live broadcast, the streamer may perform the trigger operation for displaying the target control on the media playback page of the user at an appropriate time. Accordingly, flexibility of displaying the target control can be improved.

In some embodiments, the user may interact with the target control. In some embodiments, if the trigger operation on the target control is received, the object list may be displayed on the media playback page. In some embodiments, the trigger operation may be a trigger operation for the object attribute information of the target object in the target control, and the object collection may be displayed in the form of the object list. In addition, the object collection may be displayed on the media playback page, and the target object may be placed at the top or the position close to the top in the object list, or the content currently displayed in the object list is adjusted to information related to the target object.

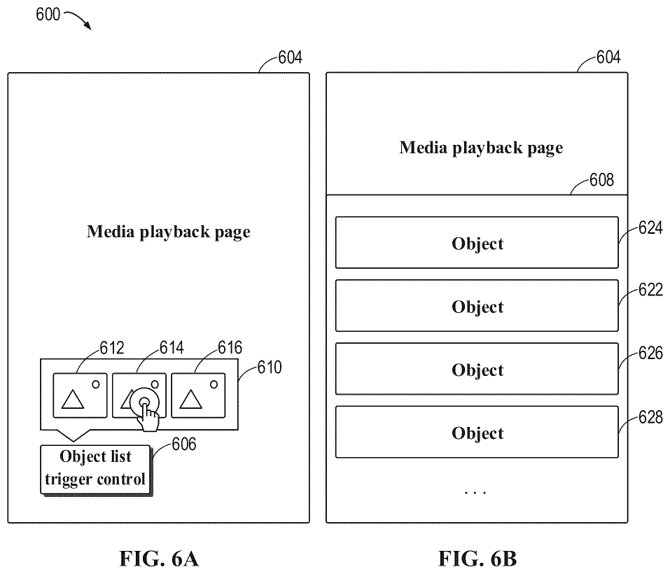

FIG. 6A to FIG. 6B illustrate schematic diagrams of an example 600 of displaying an object list by triggering a target control according to some embodiments of the present disclosure. As shown in FIG. 6A, in the example 600, a media playback page 604 includes an object list trigger control 606, and if the user triggers the object list trigger control 606, an object collection may be displayed on the media playback page 604. At a certain moment when the user enters the media playback page 604, a target control 610 may be displayed on the media playback page 604, the target control 610 includes images 612, 614, and 616, and each image may correspond to a different object in the object collection.

In the example 600, the user may tap the image 614 in the target control 610, and the operation may trigger the display of an object list on the media playback page 604. As shown in FIG. 6B, after tapping the image 614, the object list 608 may be displayed on the media playback page 604. The object list 608 may include an object 622 corresponding to the image 612, an object 624 corresponding to the image 614, an object 626 corresponding to the image 616, and an object 628 that has a corresponding image not displayed in the target control 610. Since the user taps the image 614 in the target control 610, in the pop-up object list, the plurality of objects may be reordered, and the object 624 corresponding to the image 614 is placed at the top of the object list. In this way, the tap on the image 614 by the user indicates that the user is interested in the object corresponding to the image, and therefore the corresponding object 624 is placed at the top of the object list to allow the user to quickly find the object of interest, thereby shortening time for the user to find the object 624, and reducing needed operations.

In some embodiments, the object list 608 may be positioned to the location of the object 624 without reordering the objects in the object list 608. The operation and the time for scrolling through the object collection to find the object 624 may be saved for the user as well. In some embodiments, if the user taps any area within the target control 610, objects corresponding to all images in the target control 610 may be placed at the top of the pop-up object list 608, thereby fully displaying a group of objects with an association relationship within the view of the user, and saving the operation and the time for the user to respectively search for the objects corresponding to the images 612, 614, and 616.

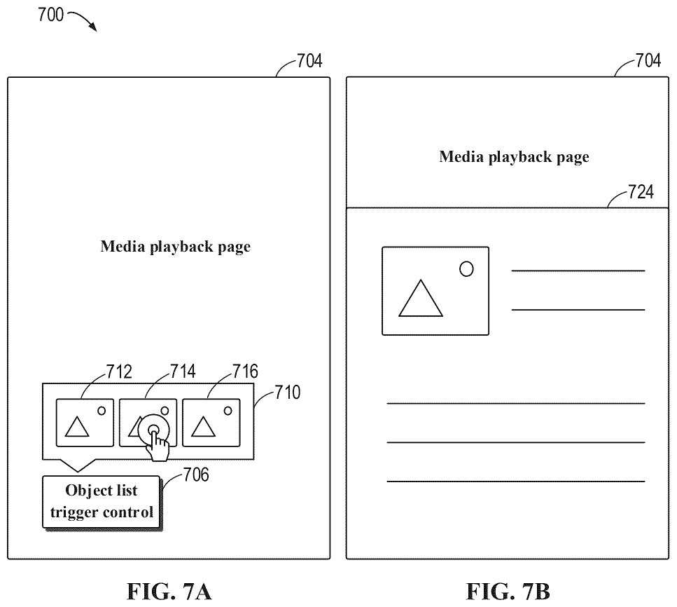

In some embodiments, if a trigger operation on object attribute information of a target object in the target control is received, detailed information of the target object may be displayed on the media playback page. FIG. 7A to FIG. 7B illustrate schematic diagrams of an example 700 of displaying detailed information of a target object by triggering the target object in a target control according to some embodiments of the present disclosure. As shown in FIG. 7A, in the example 700, a media playback page 704 includes an object list trigger control 706, and if the user triggers the object list trigger control 706, an object list may be displayed on the media playback page 704. At a certain moment when the user enters the media playback page 704, a target control 710 may be displayed on the media playback page 704, the target control 710 includes images 712, 714, and 716, and each image may correspond to a different object in the object list.

In the example 700, the user may tap the image 714 in the target control 710, and the operation may trigger the display of detailed information of an object corresponding to the image 714 on the media playback page 704. As shown in FIG. 7B, after tapping the image 714, the detailed information 724 of the object corresponding to the image 714 may be displayed on the media playback page 704. In this way, the user may view the detailed information of the object of interest through a one-time tap operation, without the need to first view the object list and then tap the object in the object list to view the detailed information of the object. Therefore, the method can reduce operations of the user, and save time.

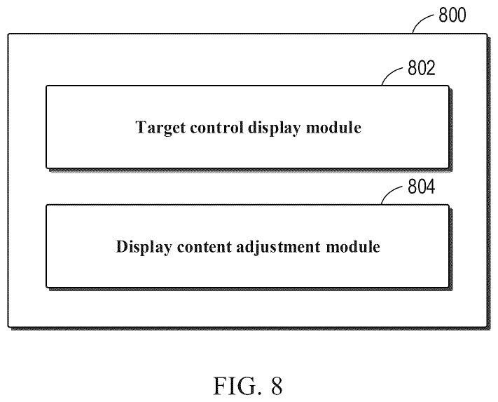

FIG. 8 illustrates a block diagram of an apparatus 800 for displaying information according to some embodiments of the present disclosure. As shown in FIG. 8, the apparatus 800 includes a target control display module 802, configured to display a target control on a media playback page in response to an interaction behavior meeting a trigger condition, where the target control at least displays object attribute information of a target object, and the target control is used to prompt the user to trigger a preset interaction operation; and the target object is determined according to object attribute information and/or business attribute information of each object in an object collection corresponding to the media playback page. The apparatus 800 further includes a display content adjustment module 804, configured to adjust content displayed in the target control to prompt information associated with the target object in response to interaction information of the object attribute information of the target object meeting a preset condition, to prompt the user to trigger the preset interaction operation.

It should be understood that by utilizing the apparatus 800 in the present disclosure, at least one of the many advantages capable of being implemented in the method or the process described above may be achieved. For example, through the apparatus 800, when the user views the object attribute information in the target control, the user may intuitively learn what information or functions are hidden behind an icon of an object list trigger control, thereby increasing a click-through rate of the object list trigger control. Moreover, after viewing the object attribute information in the target control, the user may also view the prompt information associated with the target object, thereby allowing the user to further understand that the target object in the target control may be found by tapping the object list trigger control, or further improving the interest of the user in tapping the object list trigger control, so as to further increase the click-through rate of the object list trigger control. In addition, by sequentially displaying the object attribute information and the prompt information, the number and size of controls on the page can be reduced, the simplicity of the media playback page is improved, and the display efficiency of the media content is improved.

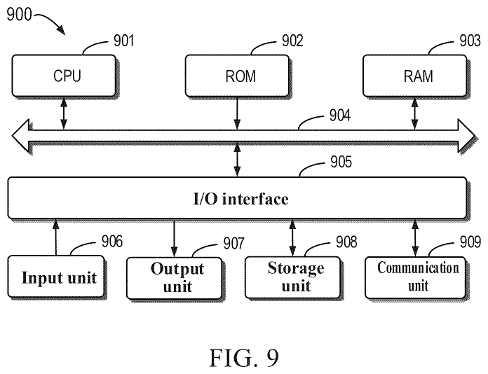

FIG. 9 illustrates a block diagram of a device 900 capable of implementing a plurality of embodiments of the present disclosure. The device 900 may be a device or apparatus described in the embodiments of the present disclosure. For example, the device 900 may be the user device 102 shown in FIG. 1A. As shown in FIG. 9, the device 900 includes a central processing unit (CPU) and/or a graphics processing unit (GPU) 901, which may perform various suitable actions and processing according to computer program instructions stored in a read-only memory (ROM) 902 or computer program instructions loaded from a storage unit 908 into a random access memory (RAM) 903. The RAM 903 may also store various programs and data required for the operation of the device 900. The CPU/GPU 901, the ROM 902, and the RAM 903 are connected to one another through a bus 904. An input/output (I/O) interface 905 is also connected to the bus 904. Although not shown in FIG. 9, the device 900 may also include a coprocessor.

A plurality of components in the device 900 are connected to the I/O interface 905, including an input unit 906 such as a keyboard and a mouse; an output unit 907 such as various types of displays and speakers; the storage unit 908 such as a disk and an optical disk; and a communication unit 909 such as a network card, a modem, and a wireless communication transceiver. The communication unit 909 allows the device 900 to exchange information/data with other devices through a computer network such as the Internet, and/or various telecommunication networks.

The various methods or processes described above may be performed by the CPU/GPU 901. For example, in some embodiments, the method may be implemented as a computer software program that is tangibly included in a non-transitory machine-readable medium, such as the storage unit 908. In some embodiments, part or all of the computer program may be loaded and/or installed onto the device 900 via the ROM 902 and/or the communication unit 909. When the computer program is loaded onto the RAM 903 and executed by the CPU/GPU 901, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operation of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to the external computer (e.g., utilizing an Internet service provider for Internet connectivity). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or the another programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the various embodiments of the present disclosure. In this regard, each block in the flowcharts or the block diagrams may represent a module, a program segment, or a portion of code, and the module, the program segment, or the portion of code includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

Some example implementations of the present disclosure are listed below.

Example 1. A method for displaying information, including:

displaying, in response to an interaction behavior meeting a trigger condition, a target control on a media playback page, where the target control at least displays object attribute information of a target object, the target control is used to prompt a user to trigger a preset interaction operation, and the target object is determined according to object attribute information and/or business attribute information of each object in an object collection corresponding to the media playback page; and

adjusting, in response to interaction information of the object attribute information of the target object meeting a preset condition, content displayed in the target control to prompt information associated with the target object, to prompt the user to trigger the preset interaction operation.

Example 2. The method according to Example 1,

where the object attribute information of the target object is an image or text information describing attributes of the target object, and the object attribute information of the target object comprises at least one of: a name, a category, a text description, and an image, and/or,

where the object attribute information of the target object comprises an image of the target object, and the prompt information comprises text information indicating how to view the object collection or text information for a supplementary description of the object attribute information of the target object.

Example 3. The method according to Examples 1 to 2, where the target object comprises a plurality of target objects, and the plurality of target objects meet at least one of the following conditions:

a value of a preset attribute of a target object in the plurality of target objects meeting a preset attribute threshold, where the preset attribute threshold is determined according to a value of the preset attribute of an object other than the plurality of target objects; or,

the plurality of target objects being a group of objects with an association relationship.

Example 4. The method according to Examples 1 to 3, the plurality of target objects are a group of objects with an association relationship in the object collection, and the prompt information is information describing the association relationship or business information indicating a combination of the plurality of target objects.

Example 5. The method according to Examples 1 to 4, where the interaction information of the object attribute information of the target object is information updated in response to detecting an interaction with the object attribute information of the target object, or statistical information associated with the object attribute information of the target object.

Example 6. The method according to Examples 1 to 5,

where adjusting the content displayed in the target control to the prompt information associated with the target object in response to the interaction information of the object attribute information of the target object meeting the preset condition comprises:

adjusting the content displayed in the target control to the prompt information in response to display time of the object attribute information of the target object exceeding a first time threshold; and

hiding the target control in response to the display time of the prompt information exceeding a second time threshold, and/or,

where adjusting the content displayed in the target control to the prompt information associated with the target object in response to the interaction information of the object attribute information of the target object meeting the preset condition comprises:

adjusting the content displayed in the target control to the prompt information in response to detecting interaction with the object attribute information of the target object; or,

adjusting the content displayed in the target control to the prompt information in response to detecting that the interaction with the object attribute information of the target object has ended.

Example 7. The method according to Examples 1 to 6, where the media playback page further displays a comment list control for displaying a comment list and an object list trigger control for triggering the display of the object collection, the comment list control is located above the target control, and displaying the target control on the media playback page includes:

displaying the target control above the object list trigger control and below the comment list control, where a height of the comment list control is kept unchanged.

Example 8. The method according to Examples 1 to 7, where the comment list displayed in the comment list control scrolls upwards in response to receiving a new comment, and the displaying the target control above the object list trigger control and below the comment list control includes:

moving the comment list control upwards; and

displaying the target control above the object list trigger control and below the comment list control.

Example 9. The method according to Examples 1 to 8, where the trigger condition includes at least one of:

the user entering the media playback page;

the number of times that the user triggers the display of the object collection being less than a first preset threshold;

the number of times that the user triggers the display of the object collection within preset time being less than a second preset threshold;

dwell time of the user on the media playback page exceeding a third preset threshold; and

the time the user spends watching the media content associated with the target object on the media playback page exceeding a fourth preset threshold.

Example 10. The method according to Examples 1 to 9, further including:

displaying the object collection on the media playback page in response to receiving a trigger operation on the target control, and/or,

where the trigger operation is a trigger operation for the object attribute information of the target object in the target control, the object collection is displayed in the form of an object list, and displaying the object collection on the media playback page comprises:

displaying the object collection on the media playback page, and placing the target object at a top or a position close to the top in the object list; or,

displaying the object collection on the media playback page, and adjusting content currently displayed in the object list to information related to the target object.

Example 11. The method according to Examples 1 to 10, further including:

in response to receiving a trigger operation on the object attribute information of the target object in the target control, displaying detailed information of the target object on the media playback page.

Example 12. The method according to Examples 1 to 11,

where the media playback page further displays an object list trigger control for triggering the display of the object collection, and displaying the target control on the media playback page comprises:

displaying the target control within a preset distance from the object list trigger control, and/or,

where the media playback page further displays an object list trigger control for triggering the display of the object collection, the preset condition is a first preset condition, and the method further comprises:

hiding the target control in response to interaction information of the prompt information meeting a second preset condition; and

displaying information indicating a number of objects in the object collection above the object list trigger control or within a preset range of the object list trigger control.

Example 13. An apparatus for displaying information, including:

a target control display module, configured to display, in response to an interaction behavior meeting a trigger condition, a target control on a media playback page, where the target control at least displays object attribute information of a target object, the target control is used to prompt a user to trigger a preset interaction operation, and the target object is determined according to object attribute information and/or business attribute information of each object in an object collection corresponding to the media playback page; and

a display content adjustment module, configured to adjust, in response to interaction information of the object attribute information of the target object meeting a preset condition, content displayed in the target control to prompt information associated with the target object, to prompt the user to trigger the preset interaction operation.

Example 14. The apparatus according to Example 13,

where the object attribute information of the target object is an image or text information describing attributes of the target object, and the object attribute information of the target object comprises at least one of: a name, a category, a text description, and an image, and/or,

where the object attribute information of the target object comprises an image of the target object, and the prompt information comprises text information indicating how to view the object collection or text information for a supplementary description of the object attribute information of the target object.

Example 15. The apparatus according to Examples 13 to 14, where the target object comprises a plurality of target objects, and the plurality of target objects meet at least one of the following conditions:

a value of a preset attribute of a target object in the plurality of target objects meeting a preset attribute threshold, where the preset attribute threshold is determined according to a value of the preset attribute of an object other than the plurality of target objects; or,

the plurality of target objects being a group of objects with an association relationship.

Example 16. The apparatus according to Examples 13 to 15, where the plurality of target objects are a group of objects with an association relationship in the object collection, and the prompt information is information describing the association relationship or business information indicating a combination of the plurality of target objects.

Example 17. The apparatus according to Examples 13 to 16, where the interaction information of the object attribute information of the target object is information updated in response to detecting an interaction with the object attribute information of the target object, or statistical information associated with the object attribute information of the target object.

Example 18. The apparatus according to Examples 13 to 17, where the adjusting content displayed in the target control to prompt information associated with the target object in response to interaction information of the object attribute information of the target object meeting a preset condition includes:

a first threshold judgment module, configured to adjust the content displayed in the target control to the prompt information in response to display time of the object attribute information of the target object exceeding a first time threshold; and

a second threshold judgment module, configured to hide the target control in response to the display time of the prompt information exceeding a second time threshold, and/or,

where the adjusting content displayed in the target control to prompt information associated with the target object in response to interaction information of the object attribute information of the target object meeting a preset condition includes:

a first interaction detection module, configured to adjust the content displayed in the target control to the prompt information in response to detecting interaction with the object attribute information of the target object; or,

a second interaction detection module, configured to adjust the content displayed in the target control to the prompt information in response to detecting that the interaction with the object attribute information of the target object has ended.

Example 19. The apparatus according to Examples 13 to 18, where the media playback page further displays a comment list control for displaying a comment list and an object list trigger control for triggering the display of the object collection, the comment list control is located above the target control, and displaying the target control on the media playback page includes:

a first target control display submodule, configured to display the target control above the object list trigger control and below the comment list control, where a height of the comment list control is kept unchanged.

Example 20. The apparatus according to Examples 13 to 19, where the comment list displayed in the comment list control scrolls upwards in response to receiving a new comment, and the displaying the target control above the object list trigger control and below the comment list control includes:

a comment list control movement module, configured to move the comment list control upwards; and

a target control position determination module, configured to display the target control above the object list trigger control and below the comment list control.

Example 21. The apparatus according to Examples 13 to 20, where the trigger condition includes at least one of the following:

the user entering the media playback page;

the number of times that the user triggers the display of the object collection being less than a first preset threshold;

the number of times that the user triggers the display of the object collection within preset time being less than a second preset threshold;

dwell time of the user on the media playback page exceeding a third preset threshold; and

the time the user spends watching the media content associated with the target object on the media playback page exceeding a fourth preset threshold.

Example 22. The apparatus according to Examples 13 to 21, further including:

an object collection display module, configured to the object collection on the media playback page in response to receiving a trigger operation on the target control, and/or,

where the trigger operation being a trigger operation for the object attribute information of the target object in the target control, the object collection being displayed in the form of an object list, and the displaying the object collection on the media playback page including:

a first object collection display submodule, configured to display the object collection on the media playback page, and placing the target object at a top or a position close to the top in the object list; or,

a second object collection display submodule, configured to display the object collection on the media playback page, and adjusting content currently displayed in the object list to information related to the target object.

Example 23. The apparatus according to Examples 13 to 22, further including:

a detailed information display module, configured to, in response to receiving a trigger operation on the object attribute information of the target object in the target control, display detailed information of the target object on the media playback page.

Example 24. The apparatus according to Examples 13 to 23, where the media playback page further displays an object list trigger control for triggering the display of the object collection, and displaying the target control on the media playback page includes:

a preset distance usage module, configured to display the target control within a preset distance from the object list trigger control, and/or,

the media playback page further displays an object list trigger control for triggering the display of the object collection, the preset condition is a first preset condition, and the method further includes:

a target control hiding module, configured to hide the target control in response to the interaction information of the prompt information meeting a second preset condition; and

an object number display module, configured to display information indicating the number of objects in the object collection above the object list trigger control or within a preset range of the object list trigger control.

Example 25. A device for displaying information, including:

a processor; and

a memory coupled with the processor, where the memory has instructions stored therein, the instructions, when executed by the processor, cause an electronic device to perform actions, and the actions include:

displaying, in response to an interaction behavior meeting a trigger condition, a target control on a media playback page, where the target control at least displays object attribute information of a target object, the target control is used to prompt a user to trigger a preset interaction operation, and the target object is determined according to object attribute information and/or business attribute information of each object in an object collection corresponding to the media playback page; and

adjusting content displayed in the target control to prompt information associated with the target object in response to interaction information of the object attribute information of the target object meeting a preset condition, to prompt the user to trigger the preset interaction operation.

Example 26. The device according to Example 25, where

the object attribute information of the target object is an image or text information describing attributes of the target object, and the object attribute information of the target object includes at least one of the following: a name, a category, a text description, and an image, and/or,

the object attribute information of the target object includes an image of the target object, and the prompt information includes text information indicating how to view the object collection or text information for a supplementary description of the object attribute information of the target object.

Example 27. The device according to Examples 25 to 26, where the target object comprises a plurality of target objects, and the plurality of target objects meet at least one of the following conditions:

a value of a preset attribute of a target object among the plurality of target objects meeting a preset attribute threshold, where the preset attribute threshold is determined according to values of the preset attributes of objects other than the plurality of target objects; or,

the plurality of target objects being a group of objects with an association relationship.

Example 28. The device according to Examples 25 to 27, where the plurality of target objects are a group of objects with an association relationship in the object collection, and the prompt information is information describing the association relationship, or business information indicating a combination of the plurality of target objects.

Example 29. The device according to Examples 25 to 28, where the interaction information of the object attribute information of the target object is information updated when interaction with the object attribute information of the target object is detected, or statistical information associated with the object attribute information of the target object.

Example 30. The device according to Examples 25 to 29, where the adjusting content displayed in the target control to prompt information associated with the target object in response to interaction information of the object attribute information of the target object meeting a preset condition includes:

adjusting the content displayed in the target control to the prompt information in response to display time of the object attribute information of the target object exceeding a first time threshold; and

hiding the target control in response to the display time of the prompt information exceeding a second time threshold, and/or,

the adjusting content displayed in the target control to prompt information associated with the target object in response to interaction information of the object attribute information of the target object meeting a preset condition includes:

adjusting the content displayed in the target control to the prompt information in response to detecting interaction with the object attribute information of the target object; or,

adjusting the content displayed in the target control to the prompt information in response to detecting that interaction with the object attribute information of the target object has ended.

Example 31. The device according to Examples 25 to 30, where the media playback page further displays a comment list control for displaying a comment list, and an object list trigger control for triggering the display of the object collection, the comment list control is located above the target control, and displaying the target control on the media playback page includes:

displaying the target control above the object list trigger control and below the comment list control, where a height of the comment list control is kept unchanged.

Example 32. The device according to Examples 25 to 31, where the comment list displayed in the comment list control scrolls upwards in response to receiving a new comment, and the displaying the target control above the object list trigger control and below the comment list control includes:

moving the comment list control upwards; and

displaying the target control above the object list trigger control and below the comment list control.

Example 33. The device according to Examples 25 to 32, where the trigger condition includes at least one of the following:

the user entering the media playback page;

the number of times that the user triggers the display of the object collection being less than a first preset threshold;

the number of times that the user triggers the display of the object collection within preset time being less than a second preset threshold;

dwell time of the user on the media playback page exceeding a third preset threshold; and

the time the user spends watching the media content associated with the target object on the media playback page exceeding a fourth preset threshold.

Example 34. The device according to Examples 25 to 33, where the actions further include:

displaying the object collection on the media playback page in response to receiving a trigger operation on the target control, and/or,

the trigger operation is a trigger operation for the object attribute information of the target object in the target control, the object collection is displayed in the form of an object list, and the displaying the object collection on the media playback page includes:

displaying the object collection on the media playback page, and placing the target object at a top or a position close to the top in the object list; or,

displaying the object collection on the media playback page, and adjusting content currently displayed in the object list to information related to the target object.

Example 35. The device according to Examples 25 to 34, where the actions further include:

in response to receiving a trigger operation on the object attribute information of the target object in the target control, displaying detailed information of the target object on the media playback page.

Example 36. The device according to Examples 25 to 35, where the media playback page further displays an object list trigger control for triggering the display of the object collection, and displaying the target control on the media playback page includes:

displaying the target control within a preset distance from the object list trigger control, and/or,

the media playback page further displays an object list trigger control for triggering the display of the object collection, the preset condition is a first preset condition, and the method further includes:

hiding the target control in response to the interaction information of the prompt information meeting a second preset condition; and

displaying information indicating the number of objects in the object collection above the object list trigger control or within a preset range of the object list trigger control.

The embodiments of the present disclosure have been described above. The above description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or improvements to technologies on the market, or to allow other persons of ordinary skill in the art to understand the various embodiments disclosed herein.

I/We claim:

1. A method for displaying information, comprising:
displaying a visual element on a media playback page, wherein the visual element displays object attribute information of an object, the object is determined from an object collection corresponding to the media playback page, and the object is determined based on object attribute information or business attribute information of each object in the object collection; and
adjusting content displayed in the visual element from the object attribute information to prompt information, to prompt a user to trigger a preset interaction operation, wherein the prompt information is associated with the object.

2. The method according to claim 1,
wherein the object attribute information of the object is an image or text information describing attributes of the object, and the object attribute information of the object comprises at least one of: a name, a category, a text description, and an image, or,
wherein the object attribute information of the object comprises an image of the object, and the prompt information comprises text information indicating how to view the object collection or text information for a supplementary description of the object attribute information of the object.

3. The method according to claim 1, wherein the object comprises a plurality of objects, and the plurality of objects meet at least one of the following conditions:
a value of a preset attribute of an object in the plurality of objects meeting a preset attribute threshold, wherein the preset attribute threshold is determined according to a value of the preset attribute of an object other than the plurality of objects; or,
the plurality of objects being a group of objects with an association relationship.

4. The method according to claim 3, wherein the plurality of objects are a group of objects with an association relationship in the object collection, and the prompt information is information describing the association relationship or business information indicating a combination of the plurality of objects.

5. The method according to claim 1, wherein the interaction information of the object attribute information of the object is information updated in response to detecting an interaction with the object attribute information of the object, or statistical information associated with the object attribute information of the object.

6. The method according to claim 5,
wherein adjusting the content displayed in the visual element from the object attribute information to the prompt information comprises:
adjusting the content displayed in the visual element to the prompt information in response to display time of the object attribute information of the object exceeding a first time threshold; and
hiding the visual element in response to the display time of the prompt information exceeding a second time threshold, or,
wherein adjusting the content displayed in the visual element from the object attribute information to the prompt information comprises:
adjusting the content displayed in the visual element to the prompt information in response to detecting interaction with the object attribute information of the object; or,
adjusting the content displayed in the visual element to the prompt information in response to detecting that the interaction with the object attribute information of the object has ended.

7. The method according to claim 1, wherein the visual element is a target visual element, the media playback page further displays a comment list visual element for displaying a comment list and an object list trigger visual element for triggering the display of the object collection, the comment list visual element is located above the target visual element, and displaying the target visual element on the media playback page comprises:
displaying the target visual element above the object list trigger visual element and below the comment list visual element, wherein a height of the comment list visual element is kept unchanged.

8. The method according to claim 7, wherein the comment list displayed in the comment list visual element scrolls upwards in response to receiving a new comment, and displaying the target visual element above the object list trigger visual element and below the comment list visual element comprises:
moving the comment list visual element upwards; and
displaying the target visual element above the object list trigger visual element and below the comment list visual element.

9. The method according to claim 1, wherein the visual element is displayed in response to an interaction behavior meeting a trigger condition, and the trigger condition comprises at least one of:
detecting triggering of displaying the media playback page;
detecting that a number of times of triggering of displaying the object collection is less than a first preset threshold;
detecting that a number of times of triggering of displaying the object collection within preset time is less than a second preset threshold;
detecting that dwell time on the media playback page exceeds a third preset threshold; and
detecting that time for playing the media content associated with the object on the media playback page exceeds a fourth preset threshold.

10. The method according to claim 1, further comprising:
displaying the object collection on the media playback page in response to receiving a trigger operation on the visual element, or,
wherein the trigger operation is a trigger operation for the object attribute information of the object in the visual element, the object collection is displayed in the form of an object list, and displaying the object collection on the media playback page comprises:
displaying the object collection on the media playback page, and placing the object at a top or a position close to the top in the object list; or,
displaying the object collection on the media playback page, and adjusting content currently displayed in the object list to information related to the object.

11. The method according to claim 1, further comprising:
in response to receiving a trigger operation on the object attribute information of the object in the visual element, displaying detailed information of the object on the media playback page.

12. The method according to claim 1,
wherein the visual element is a target visual element, the media playback page further displays an object list trigger visual element for triggering the display of the object collection, and displaying the target visual element on the media playback page comprises:
displaying the target visual element within a preset distance from the object list trigger visual element, or,
wherein the visual element is a target visual element, the media playback page further displays an object list trigger visual element for triggering the display of the object collection, the preset condition is a first preset condition, and the method further comprises:
hiding the target visual element in response to interaction information of the prompt information meeting a second preset condition; and
displaying information indicating a number of objects in the object collection above the object list trigger visual element or within a preset range of the object list trigger visual element.

13. An electronic device, comprising:
a processor; and
a memory coupled with the processor, the memory having instructions stored therein, and the instructions, when executed by the processor, causing the electronic device to:
display a visual element on a media playback page, wherein the visual element displays object attribute information of an object, the object is determined from an object collection corresponding to the media playback page, and the object is determined based on object attribute information or business attribute information of each object in the object collection; and
adjust content displayed in the visual element from the object attribute information to prompt information, to prompt a user to trigger a preset interaction operation, wherein the prompt information is associated with the object.

14. The electronic device according to claim 13,
wherein the object attribute information of the object is an image or text information describing attributes of the object, and the object attribute information of the object comprises at least one of: a name, a category, a text description, and an image, or,
wherein the object attribute information of the object comprises an image of the object, and the prompt information comprises text information indicating how to view the object collection or text information for a supplementary description of the object attribute information of the object.

15. The electronic device according to claim 13, wherein the object comprises a plurality of objects, and the plurality of objects meet at least one of the following conditions:
a value of a preset attribute of an object in the plurality of objects meeting a preset attribute threshold, wherein the preset attribute threshold is determined according to a value of the preset attribute of an object other than the plurality of objects; or,
the plurality of objects being a group of objects with an association relationship.

16. The electronic device according to claim 15, wherein the plurality of objects are a group of objects with an association relationship in the object collection, and the prompt information is information describing the association relationship or business information indicating a combination of the plurality of objects.

17. The electronic device according to claim 13, wherein the interaction information of the object attribute information of the object is information updated in response to detecting an interaction with the object attribute information of the object, or statistical information associated with the object attribute information of the object.

18. The electronic device according to claim 17,
wherein the instructions causing the electronic device to adjust the content displayed in the visual element from the object attribute information to the prompt information further cause the electronic device to:
adjust the content displayed in the visual element to the prompt information in response to display time of the object attribute information of the object exceeding a first time threshold; and
hide the visual element in response to the display time of the prompt information exceeding a second time threshold, or,
wherein the instructions causing the electronic device to adjust the content displayed in the visual element from the object attribute information to the prompt information further cause the electronic device to:
adjust the content displayed in the visual element to the prompt information in response to detecting interaction with the object attribute information of the object; or,
adjust the content displayed in the visual element to the prompt information in response to detecting that the interaction with the object attribute information of the object has ended.

19. The electronic device according to claim 13, wherein the visual element is a target visual element, the media playback page further displays a comment list visual element for displaying a comment list and an object list trigger visual element for triggering the display of the object collection, the comment list visual element is located above the target visual element, and the instructions causing the electronic device to display the target visual element on the media playback page further cause the electronic device to:
display the target visual element above the object list trigger visual element and below the comment list visual element, wherein a height of the comment list visual element is kept unchanged.

20. A computer program product, the computer program product being tangibly stored on a non-transitory computer-readable medium and comprising machine-executable instructions, and the machine-executable instructions, when executed, causing a machine to:
display a visual element on a media playback page, wherein the visual element displays object attribute information of an object, the object is determined from an object collection corresponding to the media playback page, and the object is determined based on object attribute information or business attribute information of each object in the object collection; and
adjust content displayed in the visual element from the object attribute information to prompt information, to prompt a user to trigger a preset interaction operation, wherein the prompt information is associated with the object.
